(19) United States
(12) Patent Application Publication
(10) Pub. No.: US 2012/0172506 A1
(43) Pub. Date: Jul. 5, 2012

(54) Polyphosphonate, Method of Preparing the Same, and Flame Retardant Thermoplastic Resin Composition Including the Same

(75) Inventors: Min Soo LEE, Uiwang-si (KR); Chang Hong KO, Uiwang-si (KR); Seon Ae LEE, Uiwang-si (KR); Sang Hyun HONG, Uiwang-si (KR)

(73) Assignee: CHEIL INDUSTRIES INC., Gumi-si (KR)

(21) Appl. No.: 13/330,731

(22) Filed: Dec. 20, 2011

(30) Foreign Application Priority Data
Dec. 30, 2010 (KR) 10-2010-0139697
Nov. 3, 2011 (KR) 10-2011-0114177
Dec. 1, 2011 (KR) 10-2011-0127937

(51) Int. Cl. C08K 5/5317; C08F 30/02; C07F 9/40; C08G 65/48; C08L 69/00; C08G 79/04; C08F 8/08

(52) U.S. Cl. 524/131; 528/167; 528/169; 526/278; 525/287; 525/534; 525/461; 558/91; 558/162

(57) ABSTRACT

A polyphosphonate having an acid value of about 5.5 mg KOH/g or less and represented by Formula 1:

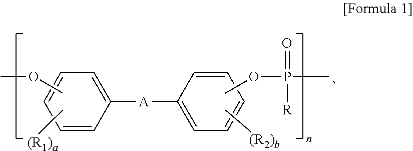

wherein: A is a single bond, C1 to C5 alkylene, C1 to C5 alkylidene, C5 to C6 cycloalkylidene, —S— or —SO2-, R is substituted or unsubstituted C6 to C20 aryl or substituted or unsubstituted C6 to C20 aryloxy, R₁ and R₂ are the same or different and are each independently substituted or unsubstituted C1 to C6 alkyl, substituted or unsubstituted C3 to C6 cycloalkyl, substituted or unsubstituted C6 to C 12 aryl or halogen, a and b are the same or different and are each independently an integer from about 0 to about 4, and n is an integer from about 1 to about 500.

### CROSS-REFERENCE TO RELATED APPLICATIONS

This application claims priority under 35 USC Section 119 to and the benefit of Korean Patent Application No. 10-2010-0139697 filed on Dec. 30, 2010, Korean Patent Application No. 10-2011-0114177 filed on Nov. 3, 2011, and Korean Patent Application No. 10-2011-0127937 filed on Dec. 1, 2011, the entire disclosure of each of which is incorporated herein by reference.

### FIELD OF THE INVENTION

The present invention relates to polyphosphonate and a flame retardant thermoplastic resin composition including the same.

### BACKGROUND OF THE INVENTION

To impart flame retardancy without use of halogen flame retardants, phosphorus flame retardants can be used. Conventionally, monomolecular phosphorus flame retardants, such as triphenyl phosphate and resorcinol bisphenol phosphate, are used. However, such monomolecular phosphorus flame retardants have a low molecular weight and thus volatilize at a high molding temperature in molding plastic, which can deteriorate the appearance of the product. Further, monomolecular phosphorus flame retardants can escape to the external environment during use of products containing the same, which can cause environmental contamination.

Polyphosphonates have received increasing attention as a polymerizable phosphorus flame retardant. Polyphosphonates in polymer form can exhibit excellent flame retardancy, mechanical properties, heat resistance, and transparency, as compared with monomolecular phosphorus flame retardants. Thus polyphosphonates can be suited for use with resins requiring high heat resistance and high transparency, such as polycarbonate resins.

Polyphosphonates may be prepared by deoxidation of a diol and phosphonic dichloride. However, phosphonic dichloride has a strong tendency to hydrolyze into phosphonic acid, which can cause decomposition of a polycarbonate resin and decomposition of polyphosphonate.

Polyphosphonates may be polymerized through solution polymerization (see, for example, U.S. Pat. Nos. 2,534,252; 3,946,093; 3,919,363), interfacial polymerization (see, for example, US Patent Publication No. 2002/0058779) and melt polymerization (see, for example, U.S. Pat. Nos. 3,719,727; 3,829,405; 3,830,771; 4,229,552). Melt polymerization can use phosphonic dialkyl or aryl instead of phosphonic dichloride and thus may not cause hydrolysis. However, this method requires specialized equipment to remove by-products and requires strict polymerization conditions. Solution polymerization and interfacial polymerization can cause hydrolysis due to the presence of phosphonic chloride at a polymer terminal.

A method of endcapping using an alcohol can prevent hydrolysis of terminal phosphonic chloride. However, if an excessive amount of an endcapping agent is used, acid value can increase and a polycarbonate resin can be decomposed due to the remaining endcapping agent. Moreover, it is not easy to remove the hydrolyzed phosphonic acid.

Conventionally, neutralization using a base containing an alkali metal is used to reduce acid value. In this case, however, alkali metal ions can remain in the polycarbonate thus decomposing the polycarbonate.

Thus, there is a need for a flame retardant for polycarbonate which has a low acid value and does not allow an agent used for reducing an acid value to remain.

### SUMMARY OF THE INVENTION

The present invention provides polyphosphonate which can have a significantly low acid value without using an endcapping agent, and a method of preparing the same. The polyphosphonate can be used as a flame retardant to provide a flame retardant thermoplastic resin composition that can exhibit excellent flame retardancy and heat resistance without causing deterioration in other physical properties.

The polyphosphonate can have an acid value of about 5.5 mg KOH/g or less and is represented by Formula 1:

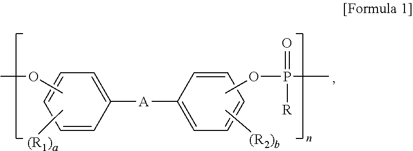

wherein:

A is a single bond, C1 to C5 alkylene, C1 to C5 alkylidene, C5 to C6 cycloalkylidene, —S— or —SO2-,

R is substituted or unsubstituted C6 to C20 aryl or substituted or unsubstituted C6 to C20 aryloxy,

R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen,

a and b are the same or different and are each independently an integer from about 0 to about 4, and

n is an integer from about 1 to about 500.

In one embodiment, the polyphosphonate may be post-treated with alkylene oxide.

In one embodiment, the polyphosphonate may have an acid value of about 4.5 mg KOH/g or less and have a structure represented by Formula 1-1:

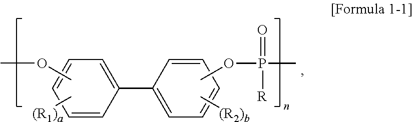

wherein:

R is substituted or unsubstituted C6 to C20 aryl or substituted or unsubstituted C6 to C20 aryloxy,

R₂ and R₂ are the same or different and are each independently substituted or unsubstituted C1 to C6 alkyl, substituted or unsubstituted C3 to C6 cycloalkyl, substituted or unsubstituted C6 to C12 aryl or halogen,

a and b are the same or different and are each independently an integer from about 0 to about 4, and

n is an integer from about 1 to about 500.

The present invention also provides a method of preparing the polyphosphonate. The method includes reacting a diol represented by Formula 2 with phosphonic dichloride represented by Formula 3, and treating the reaction product with alkylene oxide:

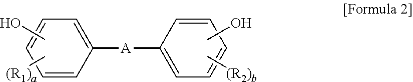

wherein:

A is a single bond, C1 to C5 alkylene, C1 to C5 alkylidene, C5 to C6 cycloalkylidene, —S— or —SO2-,

R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen, and

a and b are the same or different and are each independently an integer from about 0 to about 4; and

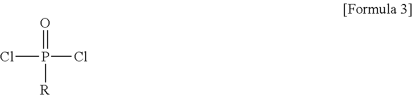

wherein R is C6 to C20 aryl or C6 to C20 aryloxy.

The alkylene oxide may be represented by Formula 4:

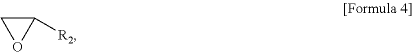

wherein R₂ is hydrogen, C1 to C6 alkyl, C6 to C20 aryl, C1 to C6 alkyl substituted C6 to C20 aryl, or C6 to C20 aralkyl.

In one embodiment, the alkylene oxide may be added in an equivalent amount of about 2 to about 7 of the acid value of the reaction product.

In another embodiment, the reaction product may be treated with the alkylene oxide after reaction with 4-cumylphenol to adjust a terminal group.

The present invention further provides polyphosphonate prepared by the method and having an acid value of about 5.5 mg KOH/g or less.

The present invention further provides a flame retardant thermoplastic resin composition including the polyphosphonate. In exemplary embodiments, the composition may include about 0.1 to about 30 parts by weight of the polyphosphonate based on about 100 parts by weight of a thermoplastic resin, such as a polycarbonate resin.

A polycarbonate of the flame retardant thermoplastic resin composition may have a number average molecular weight of about 12,000 to about 20,000 g/mol and a weight average molecular weight of about 23,000 to about 40,000 g/mol, and the flame retardant thermoplastic resin composition may have a heat distortion temperature of about 90 to about 180° C. measured according to ASTM D648 (¼, 18.6 kg).

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, the term “substituted” means that a hydrogen atom of a compound is substituted by a halogen atom, such as F, Cl, Br, and I, a hydroxyl group, a nitro group, a cyano group, an amino group, an azido group, an amidino group, a hydrazino group, a hydrazono group, a carbonyl group, a carbamyl group, a thiol group, an ester group, a carboxyl group or salt thereof, a sulfonic acid group or salt thereof, a phosphate group or salt thereof, a C1 to C20 alkyl group, a C2 to C20 alkenyl group, a C2 to C20 alkynyl group, a C1 to C20 alkoxy group, a C6 to C30 aryl group, a C6 to C30 aryloxy group, a C3 to C30 cycloalkyl group, a C3 to C30 cycloalkenyl group, a C3 to C30 cycloalkynyl group, or a combination thereof.

Polyphosphonate in accordance with the invention can have an acid value of about 5.5 mg KOH/g and is represented by Formula 1:

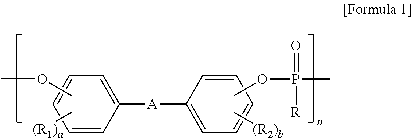

wherein:

A is a single bond, C1 to C5 alkylene, C1 to C5 alkylidene, C5 to C6 cycloalkylidene, —S— or —SO2-,

R is substituted or unsubstituted C6 to C20 aryl or substituted or unsubstituted C6 to C20 aryloxy,

R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen,

a and b are the same or different and are each independently an integer from about 0 to about 4, and

n is an integer from about 1 to about 500.

In one embodiment, the polyphosphonate may have an acid value of about 4.5 mg KOH/g or less and have a structure represented by Formula 1-1:

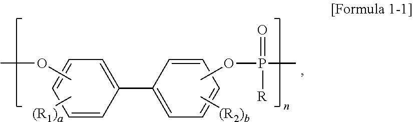

wherein:

R is substituted or unsubstituted C6 to C20 aryl or substituted or unsubstituted C6 to C20 aryloxy,

R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen,

a and b are the same or different and are each independently an integer from about 0 to about 4, and

n is an integer from about 1 to about 500.

The polyphosphonate may be prepared by reaction of a diol with phosphonic dichloride.

In one embodiment, the polyphosphonate may be prepared by reacting a diol represented by Formula 2 with phosphonic dichloride represented by Formula 3 and by treating the reaction product with alkylene oxide:

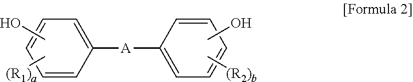

wherein:

A is a single bond, C1 to C5 alkylene, C1 to C5 alkylidene, C5 to C6 cycloalkylidene, —S— or —SO2-,

R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen, and

a and b are the same or different and are each independently an integer from about 0 to about 4.

Examples of the diol may include without limitation 4,4′-dihydroxybiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like, and combinations thereof.

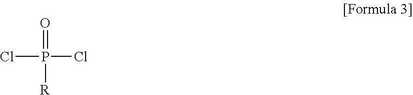

wherein R is C6 to C20 aryl or C6 to C20 aryloxy.

In exemplary embodiments, the phosphonic dichloride may be reacted with the diol in an equivalent ratio of about 1 to 1.

In one embodiment, the reaction of the diol and the phosphonic dichloride may be conducted by a general method in the presence of a Lewis acid as a catalyst. Examples of the Lewis acid may include without limitation aluminum chloride, magnesium chloride, and the like, and combinations thereof. The catalyst may be reacted with the diol in an equivalent ratio of about 0.01 or more to 1, for example about 0.01 to about 0.1 to 1.

In one embodiment, after the reaction terminates, the product may be washed with an acid solution. Examples of the acid solution may include without limitation phosphoric acid, hydrochloric acid, nitric acid, sulfuric acid, and the like, and combinations thereof. In exemplary embodiments, phosphoric acid or hydrochloric acid may be used. The acid solution may have a concentration of about 0.1 to about 10%, for example about 1 to about 5%.

The reaction product washed with the acid solution can be reacted with the alkylene oxide represented by Formula 4. In one embodiment, dehydration for removal of water is conducted before reaction with the alkylene oxide, thereby stably conducting the reaction.

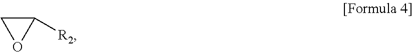

wherein R₂ is hydrogen, C1 to C6 alkyl, C6 to C20 aryl, C1 to C6 alkyl substituted C6 to C20 aryl or C6 to C20 aralkyl.

In one embodiment, R₂ may be C1 to C6 alkyl.

In one embodiment, the alkylene oxide may be added in an equivalent amount of about 2 to about 7, for example about 3 to about 5, of the acid value of the reaction product. When the alkylene oxide is added in an equivalent amount within this range, an excellent balance of physical properties can be obtained.

The reaction of the reaction product with the alkylene oxide may be conducted for about 1 minute to about 24 hours, for example about 1 to about 20 hours. Reaction temperature may be about 30 to about 150° C.

In the present invention, due to use of the alkylene oxide, an acid value may decrease and the alkylene oxide is entirely washed out in washing. Thus, when the polyphosphonate is used with a polycarbonate resin, metal ions do not remain in the resin.

Alternatively, before the reaction with the alkylene oxide, the reaction product may further be subjected to endcapping by a general method. In one embodiment, the reaction product may be reacted with 4-cumylphenol to adjust a terminal group and then can be treated with the alkylene oxide.

After reaction of the reaction product with the alkylene oxide, washing and filtering may further be carried out.

The polyphosphonate prepared as above may have an acid value of about 5.5 mg KOH/g or less, for example about 4.5 mg KOH/g or less, and as another example about 0.01 to about 3 mg KOH/g.

In particular, if polyphosphonate contains a biphenyl group, the polyphosphonate may have an acid value of about 1 mg KOH/g or less, for example about 0.5 mg KOH/g or less, and as another example about 0.001 to about 0.3 mg KOH/g.

As such, the polyphosphonate can have a significantly low acid value, and thus may not cause decomposition of a thermoplastic resin when mixed therewith and can be suited for use as a flame retardant.

The present invention also relates to a flame retardant thermoplastic resin composition including the polyphosphonate.

There is no particular restriction as to the kind of the thermoplastic resin. Examples of the thermoplastic resin may include without limitation styrene resins, polyamide resins, polycarbonate resins, polyester resins, polyvinyl chloride resins, styrene copolymer resins, (meth)acrylic resins, polyphenylene ether resins, and the like, and combinations thereof.

The polyphosphonate prepared by the method according to the present invention can have a low acid value and can exhibit flame retardancy, heat resistance and transparency and thus may be used with resins requiring high heat resistance and high transparency.

In one embodiment, the flame retardant thermoplastic resin composition may include about 0.1 to about 30 parts by weight, for example about 1 to about 15 parts by weight, of the polyphosphonate based on about 100 parts by weight of a thermoplastic resin, such as a polycarbonate resin. In some embodiments, the flame retardant thermoplastic resin composition may include the polyphosphonate in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the polyphosphonate can be in a range from about any of the foregoing amounts to about any other of the foregoing amounts.

The flame retardant thermoplastic resin composition may not cause decomposition of polycarbonate. The polycarbonate may have a number average molecular weight of about 12,000 to about 20,000 g/mol and a weight average molecular weight of about 23,000 to about 40,000 g/mol, and the flame retardant thermoplastic resin composition may have a heat distortion temperature of about 90 to about 180° C. measured according to ASTM D648 (¼, 18.6 kg).

The present invention will be explained in more detail with reference to the following examples. These examples are provided for illustrative purposes only and are not to be in any way construed as limiting the present invention.

### EXAMPLES

Preparation of Polyphosphonate

### Examples 1 to 5

### Preparation of Polyphosphonate

1 equivalent of bisphenol A (Kumho Co., Ltd.) and 0.01 equivalents of aluminum chloride are added to dichlorobenzene (Samchun Chemical Co., Ltd.) and thoroughly mixed through stirring while heating to 140° C. When the temperature reaches 140° C., a mixture of 1 equivalent of phenyldichloride phosphonate (Acros Co., Ltd.) with dichlorobenzene (Samchun Chemical Co., Ltd.) is dropped thereinto, thereby initiating reaction. After completion of dropping, the product is further stirred for 8 hours, and then the reaction terminated. Then, the product is washed with a 30% or less hydrochloric acid solution, followed by elimination of a water layer, elimination of dichlorobenzene through vacuum distillation, and then measurement of an acid value. Toluene and 5 equivalents of propylene oxide (Aldrich Co., Ltd.) of the acid value are added to the product, which is heated to 130° C., followed by stirring for a period of time listed in Table 1. Temperature is lowered to room temperature, and the product is washed with water twice and deposited in normal hexane, thereby obtaining a final product.

### Examples 6 to 8

### Preparation of Polyphosphonate Containing Biphenyl Group

1 equivalent of biphenol (Songwon Industrial Co., Ltd.) and 0.01 equivalents of aluminum chloride are added to dichlorobenzene (Samchun Chemical Co., Ltd.) and thoroughly stirred while heating to 140° C. When the temperature reaches 140° C., a mixture of 1 equivalent of phenyldichloride phosphonate (Acros Co., Ltd.) with dichlorobenzene (Samchun Chemical Co., Ltd.) is dropped thereinto, thereby initiating reaction. After completion of dropping, the product is further stirred for 8 hours, and then the reaction terminated. Then, the product is washed with a 30% or less hydrochloric acid solution, followed by elimination of a water layer, elimination of dichlorobenzene through vacuum distillation, and then measurement of an acid value. Toluene and 6 equivalents of propylene oxide (Aldrich Co., Ltd.) of the acid value are added to the product, which is heated to 130° C., followed by stirring for a period of time listed in Table 2. Temperature is lowered to room temperature, and the product is washed with water twice and deposited in normal hexane, thereby obtaining a final product.

### Comparative Example 1

The same process as in Example 1 is carried out except that treatment with propylene oxide is not conducted.

### Comparative Example 2

The same process as in Example 6 is carried out except that treatment with propylene oxide is not conducted.

The polyphosphonates prepared in Examples 1 to 8 and Comparative Examples 1 and 2 are evaluated as to acid value and yield by the following method, and results are listed in Tables 1 and 2.

Acid value (mg KOH/g): 1 to 20 g of a sample is dissolved in dimethyl sulfoxide (50 ml) and 0.03 to 0.2 ml of a bromothymol blue (BTB) solution is added thereto, after which the Consumed amount of 0.1N—NaOH solution is measured by titration with a 0.1N NaOH solution. The acid value of the mixture is calculated by the following equation 1:

Acid value=((Consumed amount of 0.1N—NaOH solution (ml))*(0.1N—NaOH solution Factor)*5.61)/amount of sample (g) [Equation 1]

TABLE 1

| | Process time (h) | Acid value |
|---|---|---|
| Example 1 | 1 | 5.1 |
| Example 2 | 2 | 3.9 |
| Example 3 | 4 | 2.0 |
| Example 4 | 8 | 1.2 |
| Example 5 | 20 | 0.8 |
| Comparative | 0 | >20 |
| Example 1 | | |

In Table 1, it can be seen that Examples 1 to 5 employing the method of the present invention exhibit a remarkably low acid value as compared with Comparative Example 1.

TABLE 2

| | Process time (h) | Acid value |
|---|---|---|
| Example 6 | 1 | 0.1 |
| Example 7 | 2 | 0.01 |
| Example 8 | 4 | 0.01 |
| Comparative | 0 | >6 |
| Example 2 | | |

Preparation of Thermoplastic Resin Composition

Polyphosphonate prepared in each of Examples 1 to 8 and Comparative Examples 1 and 2 is added to 100 parts by weight of polycarbonate and extruded into pellets using a general biaxial extruder at 200 to 280° C. 0.01 to 0.015 g of these pellets are dissolved in a 2 ml MC, and the solution is diluted with about 10 ml of THF and then filtered through a 0.45 μm syringe filter. Molecular weight is measured by gel permeation chromatography (GPC) and flame retardancy at a thickness of ⅛″ is measured according to UL94 VB standards. Heat resistance (unit: ° C.) is measured according to ASTM D648 (¼, 18.6 kg).

### Comparative Example 3

The same process as above is carried out except that phosphate ester (PX-200, Daihachi Co., Ltd.) is used as a flame retardant in 100 parts by weight of polycarbonate having a number average molecular weight of 12,700 g/mol and weight average molecular weight of 24,300 g/mol.

TABLE 3

| | | | | Molecular weight | | | |
|---|---|---|---|---|---|---|---|
| | | | | of PC | | | |
| | Composition (Phr.) | | | Mn | Mw | Flame | Heat |
| No. | Polyphosphonate | PX-200 | PC | (g/mol) | (g/mol) | retardancy | resistance |
| Example 1 | 5 | — | 100 | 12900 | 25000 | V-2 | 140 |
| Example 2 | 5 | — | 100 | 14100 | 26200 | V-0 | 141 |
| Example 3 | 5 | — | 100 | 14100 | 26800 | V-0 | 141 |
| Example 4 | 5 | — | 100 | 14100 | 26900 | V-0 | 142 |
| Example 5 | 5 | — | 100 | 14300 | 27000 | V-0 | 143 |
| Comparative | 5 | — | 100 | 11500 | 22900 | V-2 | 139 |
| Example 1 | | | | | | | |
| Comparative | — | 5 | 100 | 12700 | 24300 | V-0 | 133.3 |
| Example 3 | | | | | | | |

TABLE 4

| | | | | Molecular weight | | | |
|---|---|---|---|---|---|---|---|
| | | | | of PC | | | |
| | Composition (Phr.) | | | Mn | Mw | Flame | Heat |
| No. | Polyphosphonate | PX-200 | PC | (g/mol) | (g/mol) | retardancy | resistance |
| Example 6 | 5 | — | 100 | 12200 | 24400 | V-0 | 140.5 |
| Example 7 | 5 | — | 100 | 13800 | 25400 | V-0 | 140.7 |
| Example 8 | 5 | — | 100 | 14500 | 26000 | V-0 | 141.0 |
| Comparative | 5 | — | 100 | 11600 | 22700 | V-2 | 139 |
| Example 2 | | | | | | | |
| Comparative | — | 5 | 100 | 12700 | 24300 | V-0 | 133.3 |
| Example 3 | | | | | | | |

As shown in Tables 3 and 4, the polyphosphonate prepared by the method according to the present invention did not cause decomposition of polycarbonates, and thus the polycarbonate has a high molecular weight. Further, the resin compositions have excellent heat resistance as compared with those in Comparative Examples 3 and 4, which use a monomolecular phosphorus flame retardant.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

Although specific terms are employed herein, they are used in a generic and descriptive sense only and not for purposes of limitation, the scope of the invention being defined in the claims.

What is claimed is:

1. Polyphosphonate having an acid value of about 5.5 mg KOH/g or less and represented by Formula 1: 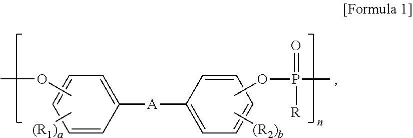
wherein:
A is a single bond, C1 to C5 alkylene, C1 to C5 alkylidene, C5 to C6 cycloalkylidene, —S— or —SO2-,
R is substituted or unsubstituted C6 to C20 aryl or substituted or unsubstituted C6 to C20 aryloxy,
R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen,
a and b are the same or different and are each independently represent an integer from about 0 to about 4, and
n is an integer from about 1 to about 500.

2. The polyphosphonate of claim 1, wherein the polyphosphonate is post-treated with alkylene oxide.

3. The polyphosphonate of claim 1, wherein the polyphosphonate has a structure represented by Formula 1-1: 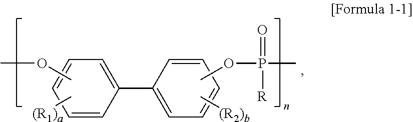
wherein:
R is substituted or unsubstituted C6 to C20 aryl or substituted or unsubstituted C6 to C20 aryloxy,
R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen,
a and b are the same or different and are each independently an integer from about 0 to about 4, and
n is an integer from about 1 to about 500.

4. The polyphosphonate of claim 1, wherein the polyphosphonate has an acid value of about 4.5 mg KOH/g or less.

5. A method of preparing polyphosphonate represented by Formula 1, comprising: reacting a diol represented by Formula 2 with phosphonic dichloride represented by Formula 3; and treating the reaction product with alkylene oxide: 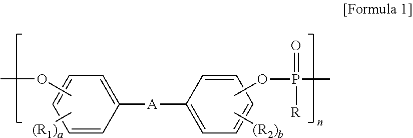
wherein:
A is a single bond, C1 to C5 alkylene, C1 to C5 alkylidene, C5 to C6 cycloalkylidene, —S— or —SO2-,
R is substituted or unsubstituted C6 to C20 aryl or substituted or unsubstituted C6 to C20 aryloxy,
R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen,
a and b are the same or different and are each independently an integer from about 0 to about 4, and
n represents an integer from about 1 to about 500; 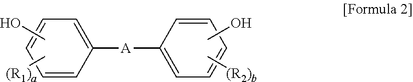
wherein:
A is a single bond, C1 to C5 alkylene, C1 to C5 alkylidene, C5 to C6 cycloalkylidene, —S— or —SO2-,
R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen, and
a and b are the same or different and are each independently an integer from about 0 to about 4; and 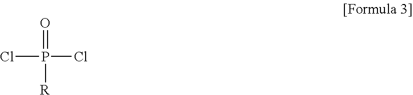
wherein R is C6 to C20 aryl or C6 to C20 aryloxy.

6. The method of claim 5, wherein the alkylene oxide is represented by Formula 4: 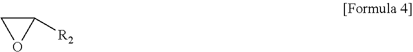
wherein R₂ is hydrogen, C1 to C6 alkyl, C6 to C20 aryl, C1 to C6 alkyl alkyl substituted C6 to C20 aryl or C6 to C20 aralkyl.

7. The method of claim 5, wherein the alkylene oxide is added in an equivalent of about 2 to about 7 of the acid value of the reaction product.

8. The method of claim 5, wherein the reaction product is treated with the alkylene oxide after reaction with 4-cumylphenol to adjust a terminal group.

9. Polyphosphonate prepared by the method of claim 5 and having an acid value of about 5.5 mg KOH/g or less.

10. A flame retardant thermoplastic resin composition comprising the polyphosphonate of claim 9.

11. The flame retardant thermoplastic resin composition of claim 10, wherein the composition comprises about 0.01 to about 30 parts by weight of the polyphosphonate based on about 100 parts by weight of polycarbonate resin.

12. The flame retardant thermoplastic resin composition of claim 11, wherein the polycarbonate resin has a number average molecular weight of about 12,000 to about 20,000 g/mol and a weight average molecular weight of about 23,000 to about 40,000 g/mol, and the flame retardant thermoplastic resin composition has a heat distortion temperature of about 90 to about 180° C. measured according to ASTM D648 (¼, 18.6 kg).
